(19) United States
(12) Patent Application Publication
(10) Pub. No.: US 2010/0228381 A1
(43) Pub. Date: Sep. 9, 2010

(54) THREE-DIMENSIONAL MODELING APPARATUS AND THREE-DIMENSIONAL OBJECT

(75) Inventors: Takeshi Matsui, Tokyo (JP); Junichi Kuzusako, Saitama (JP); Hiroyuki Yasukochi, Kanagawa (JP)

Correspondence Address: K&L Gates LLP, P. O. BOX 1135, CHICAGO, IL, 60690, US

(73) Assignee: SONY CORPORATION, Tokyo (JP)

(21) Appl. No.: 12/715,120

(22) Filed: Mar. 1, 2010

(30) Foreign Application Priority Data
Mar. 9, 2009 (JP) P2009-054600

(51) Int. Cl. G06F 17/00

(52) U.S. Cl. 700/120; 700/119

(57) ABSTRACT

A three-dimensional modeling apparatus includes a stage, a supply mechanism, a head, a movement mechanism, and a lifting and lowering mechanism. On the stage, a powder material is accumulated. The supply mechanism supplies the powder material on the stage for each predetermined layer thickness. The head ejects a liquid for forming a three-dimensional object to the powder material on the stage. The liquid is capable of binding the powder material. The movement mechanism moves the stage so that the liquid is supplied from the head to the powder material by the predetermined layer thickness. The lifting and lowering mechanism lowers the stage for each predetermined layer thickness.

### CROSS REFERENCES TO RELATED APPLICATIONS

The present application claims priority to Japanese Priority Patent Application JP 2009-054600 filed in the Japan Patent Office on Mar. 9, 2009, the entire content of which is hereby incorporated by reference.

### BACKGROUND

The present invention relates to a three-dimensional modeling apparatus that forms a three-dimensional shape by laminating pieces of data of cross sectional images, and a three-dimensional object formed with the three-dimensional modeling apparatus.

In the past, a three-dimensional modeling apparatus of this type has been known as an apparatus of rapid prototyping, which is widespread for professional use. As main methods for the three-dimensional modeling apparatus, stereo-lithography, laminated object manufacturing, and modeling with powders are used, for example.

The stereo-lithography refers to a method of irradiating a light curing resin with high-power laser light, forming cross sections thereof, and creating a three-dimensional shape by laminating the cross sections. The laminated object manufacturing refers to a method of cutting thin sheets off in a layered manner and bonding and laminating the sheets, thereby creating a three-dimensional shape. The modeling with powders refers to a method of bedding powder materials in a layered manner, forming cross sections, and creating a three-dimensional shape by laminating the cross sections.

Further, the modeling with powders is roughly classified into two methods, i.e., a method of fusing or sintering powders and a method of solidifying powders by using adhesive. In the latter method, the adhesive is ejected to powders mainly containing gypsum by using an inkjet head used for a printer or the like to solidify the powders and form and laminate cross-sectional layers, thereby creating a three-dimensional shape.

In the modeling with powders with the use of an inkjet head, a head of an inkjet printer ejects a binder solution for binding the powders while moving on a sheet on which gypsum powders are bedded, as if printing is performed. In this method, a high-power laser is not used unlike the stereo-lithography, and therefore an apparatus is easily handled. In addition, a light curing resin is not used, and therefore a burden on an environment is relatively small, and a troublesome task such as the management of a resin is less necessary.

There has been proposed an apparatus that uses the above-mentioned method of modeling with powders (see, for example, Japanese Patent Translation Publication No. HEI07-507508 (hereinafter, referred to as Patent Document 1). In Patent Document 1, as shown in FIG. 2 of Patent Document 1, a head 41 (powder dispersion head 13) for ejecting powders supplies the powders while moving above an area 42 in which the powders are stored. Further, a head 43 (inkjet printing head 15) for ejecting a binding material for binding the powders selectively ejects the binding material to the powders while moving above the area 42, thereby forming a binder layer (disclosed in page 7 of the specification of Patent Document 1). In addition, as shown in FIG. 7 of Patent Document 1, this apparatus has a structure in which a horizontal roller 101 for leveling a surface of the powders supplied is also moved.

### SUMMARY

As described above, because at least the three members, that is, the heads 41 and 43 and the horizontal roller 101 are moved above the area 42, mechanisms for moving those members are necessary, which makes the structure complicated.

In view of the above-mentioned circumstances, it is desirable to provide a three-dimensional modeling apparatus that enables the powders, liquid, or the like to be supplied with a simple mechanism, and provide a three-dimensional object capable of being created by the three-dimensional modeling apparatus.

According to an embodiment, there is provided a three-dimensional modeling apparatus including a stage, a supply mechanism, a head, a movement mechanism, and a lifting and lowering mechanism.

On the stage, a powder material is accumulated.

The supply mechanism supplies the powder material on the stage for each predetermined layer thickness.

The head ejects a liquid for forming a three-dimensional object to the powder material on the stage. The liquid is capable of binding the powder material.

The movement mechanism moves the stage so that the liquid is supplied from the head to the powder material by the predetermined layer thickness.

The lifting and lowering mechanism lowers the stage for each predetermined layer thickness.

In the embodiment, the stage is moved by the movement mechanism. Therefore, the supply of the powder material or the ejection of the liquid can be performed without moving at least one of the supply mechanism and the head in a direction parallel to the movement direction of the stage. In other words, the supply of at least one of the powder materials and the liquid can be performed by moving the stage by the movement mechanism, which can make the structure of a movement system simple.

The movement system refers to a mechanism for moving the members, which is necessary for forming a three-dimensional object by the predetermined layer thickness of the powder material.

The supply mechanism may include a supply box, an accumulation surface, and a dropper mechanism.

The supply box is capable of storing the powder material and is disposed above the stage on a path of movement of the stage by the movement mechanism.

The accumulation surface is inclined in the supply box, and the powder material is accumulated on the accumulation surface.

The dropper mechanism causes the powder material accumulated on the accumulation surface to drop on the stage by a weight of the powder material during the movement of the stage by the movement mechanism.

Because the powder material is supplied from the accumulation surface to the stage by using at least the weight thereof during the movement of the stage by the movement mechanism, the supply mechanism does not have to cause the movement for laminating the powder material on the stage by one layer. That is, the supply mechanism can be fixed to the three-dimensional modeling apparatus, which makes the structure of the movement system simple.

The dropper mechanism may be a supply roller disposed on a lower end portion of the accumulation surface.

The supply mechanism may further include a leveling roller to level the powder material dropped on the stage.

With this structure, the layer thickness of the powder material can be uniform.

The supply mechanism may include a supply roller to function as the dropper mechanism, the supply roller being disposed on a lower end portion of the accumulation surface, a leveling roller to level the powder material dropped on the stage, and a drive source to drive the supply roller and the leveling roller.

Because the one drive source drives the supply roller and the leveling roller, the miniaturization of the three-dimensional modeling apparatus can be realized.

The three-dimensional modeling apparatus may further include a power transmission mechanism to drive the supply roller to rotate by using power of the stage. The power is caused when the stage is moved by the movement mechanism.

With this structure, the one drive source that drives the stage can rotate the supply roller, which can realize the miniaturization of the three-dimensional modeling apparatus.

The three-dimensional modeling apparatus may further include a power transmission mechanism to drive the leveling roller to rotate by using power of the stage. The power is caused when the stage is moved by the movement mechanism.

With this structure, the one drive source that drives the stage can rotate the leveling roller, which can realize the miniaturization of the three-dimensional modeling apparatus.

The three-dimensional modeling apparatus may further include a heater to heat the powder material on the stage, to which the liquid is supplied.

For example, in a case where a bonding force of the powders by the liquid ejected from the head is not enough, and the hardness of a three-dimensional object is insufficient, a desired hardness can be obtained by the heating process by the heater.

The heater may emit laser light for heating.

The head may be a line-type head that is fixed on a position above the stage on a path of movement of the stage by the movement mechanism and elongated in a direction perpendicular to a movement direction of the stage.

The powder material may mainly contain sodium chloride.

According to another embodiment, there is provided a three-dimensional object obtained by a three-dimensional modeling apparatus including a stage, a supply mechanism, a head, a movement mechanism, and a lifting and lowering mechanism.

On the stage, a powder material is accumulated.

The supply mechanism supplies the powder material on the stage for each predetermined layer thickness.

The head ejects a liquid for forming a three-dimensional object to the powder material on the stage. The liquid is capable of binding the powder material.

The movement mechanism moves the stage so that the liquid is supplied from the head to the powder material by the predetermined layer thickness.

The lifting and lowering mechanism lowers the stage for each predetermined layer thickness.

As described above, according to the embodiments of the present invention, the powders and the liquid can be supplied with the simple mechanism.

These and other objects, features and advantages of the present invention will become more apparent in light of the following detailed description of best mode embodiments thereof, as illustrated in the accompanying drawings.

Additional features and advantages are described herein, and will be apparent from the following Detailed Description and the figures.

### BRIEF DESCRIPTION OF THE FIGURES

FIG. 1 is a perspective view showing a three-dimensional (3-D) modeling apparatus according to a first embodiment;

FIGS. 2A and 2B are perspective views viewed from sides of the 3-D modeling apparatus;

FIG. 3 is a perspective view showing an inner structure of the 3D modeling apparatus, an approximately center portion of which is taken along a plane parallel to a Y direction of FIG. 1;

FIG. 4 is a cross-sectional view of the 3D modeling apparatus of FIG. 3;

FIG. 5 is a perspective view showing the 3D modeling apparatus in a state where all covers thereof shown in FIG. 1 are detached;

FIG. 6 is a perspective view showing the 3D modeling apparatus from which a top plate shown in FIG. 5 is detached;

FIG. 7 is a plan view of the 3D modeling apparatus shown in FIG. 6;

FIG. 8 is a block diagram mainly showing a control system of the 3D modeling apparatus;

FIG. 9 is a flowchart showing an operation of the 3D modeling apparatus;

FIG. 10 are schematic diagrams each showing the operation of the 3D modeling apparatus;

FIG. 11 is a table showing an example of measurement values of colors of four 3D objects formed by the 3D modeling apparatus according to the first embodiment;

FIG. 12 is a perspective view showing a part of a 3D modeling apparatus according to a second embodiment;

FIGS. 13A and 13B are graphs each showing an example of an operation of the heater that uses the infrared laser; and

FIG. 14 is a perspective view showing a part of a 3D modeling apparatus according to a third embodiment.

### DETAILED DESCRIPTION

The present application will be described with reference to the drawings, according to an embodiment.

### First Embodiment

### Structure of Three-Dimensional Modeling Apparatus

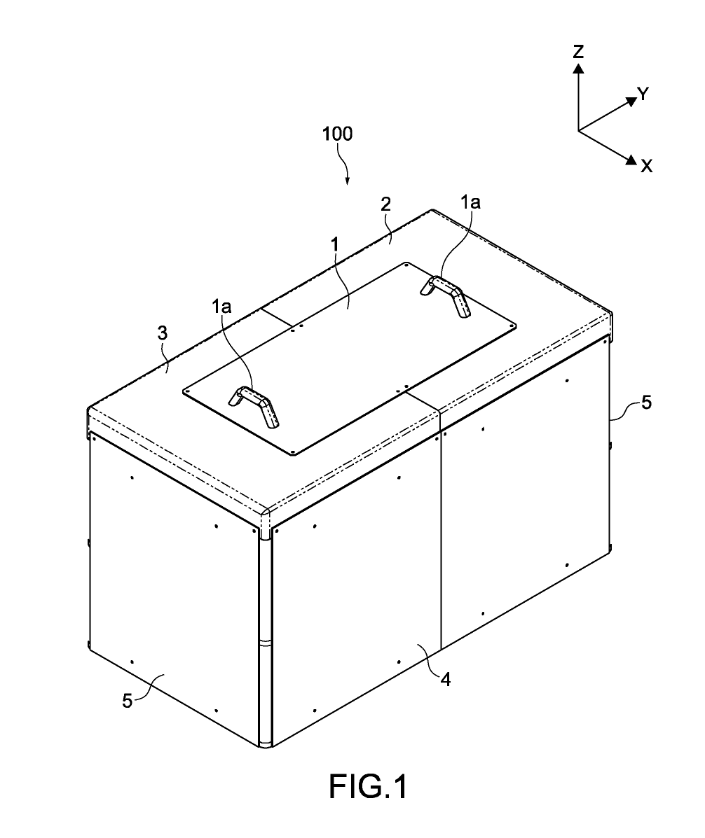

FIG. 1 is a diagram showing a three-dimensional (3-D) modeling apparatus 100 according to a first embodiment of the present invention.

The 3-D modeling apparatus 100 includes a casing whose shape is an approximately rectangular parallelepiped. The casing is constituted of a plurality of covers. Specifically, an upper portion of the casing is formed of a top cover 1 and right and left covers 2 and 3 that sandwich the top cover 1 from both sides thereof. Further, a front cover 4, side covers 5 on both side surfaces, and a back cover (not shown) are provided. The top cover 1 is provided with a handle 1a, with which the top cover 1 can be detached from the right cover 2 and the left cover 3.

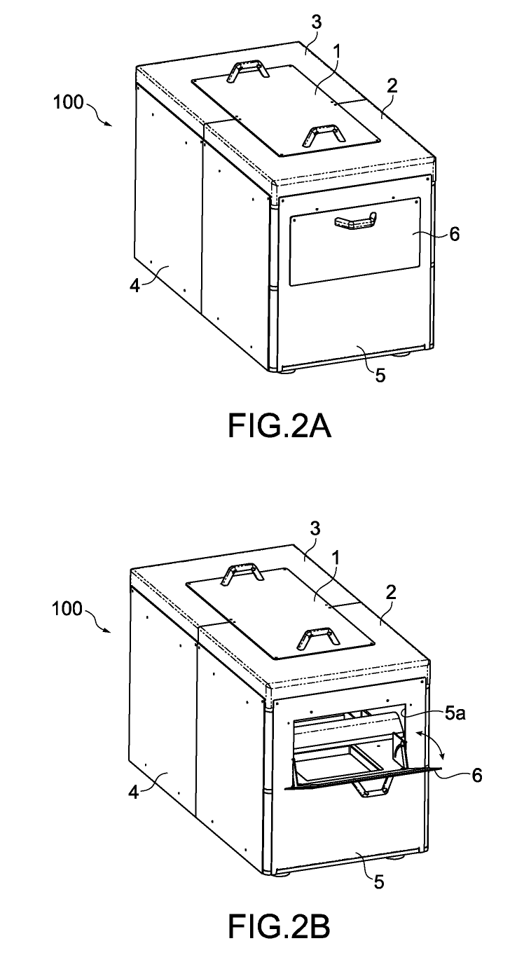

FIGS. 2A and 2B are perspective views viewed from the sides of the 3-D modeling apparatus 100. As shown in FIG. 2B, on one of the side covers 5, a takeout opening 5a for taking a created 3-D object out, and a takeout opening cover 6 is provided to the takeout opening 5a so as to be opened and closed.

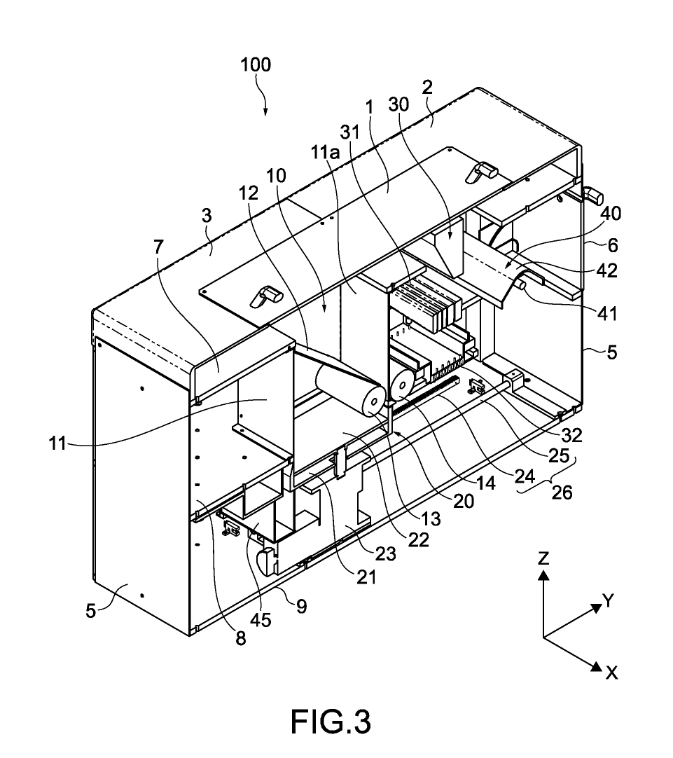

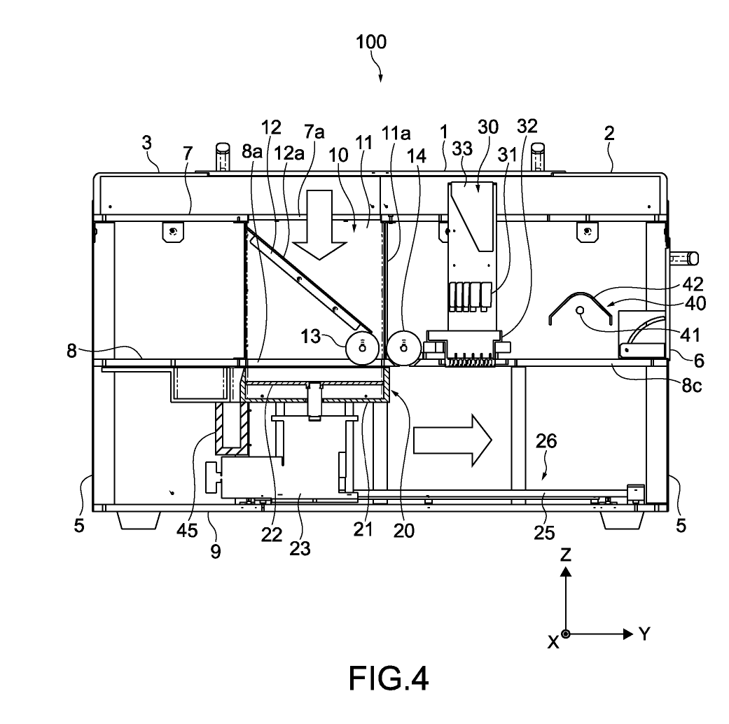

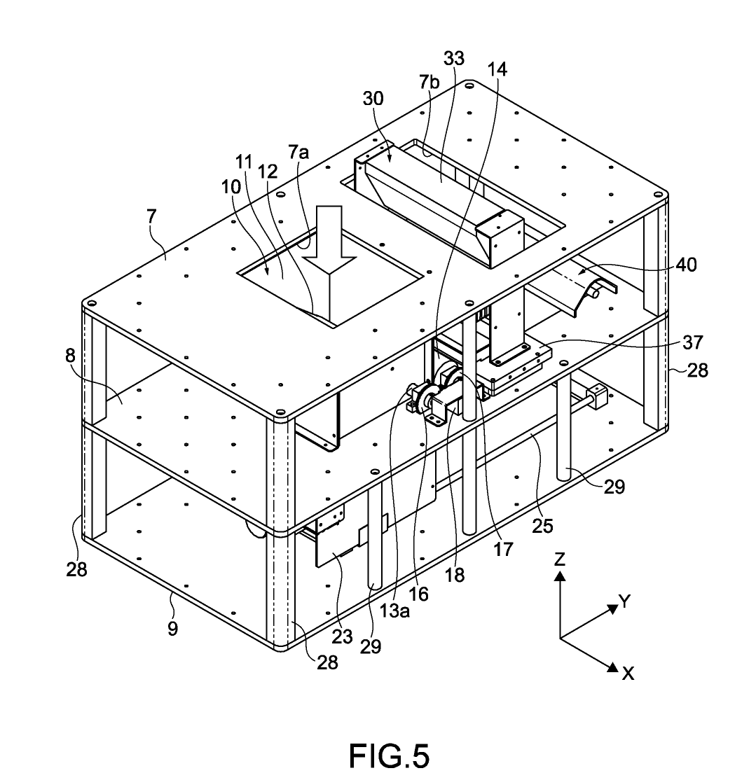

FIG. 3 is a perspective view showing an inner structure of the 3D modeling apparatus 100, an approximately center portion of which is taken along the plane parallel to a Y direction of FIG. 1. FIG. 4 is a cross-sectional view of the 3D modeling apparatus 100 of FIG. 3. FIG. 5 is a perspective view showing the 3D modeling apparatus 100 in a state where all the covers shown in FIG. 1 are detached.

As shown in FIG. 5, the 3D modeling apparatus 100 includes four support columns 28 respectively provided at four corners, for example. To the support columns 28, a base plate 9, a print base plate 8, and a top plate 7 are provided so as to be connected at predetermined intervals. Between the top plate 7 and the print base plate 8 and between the print base plate 8 and the base plate 9, a plurality of column members 29 are provided as appropriate.

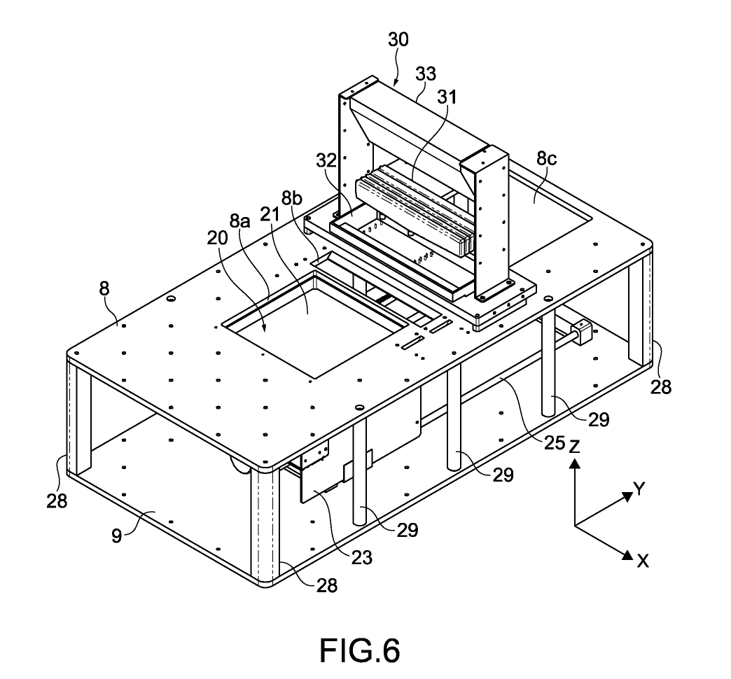

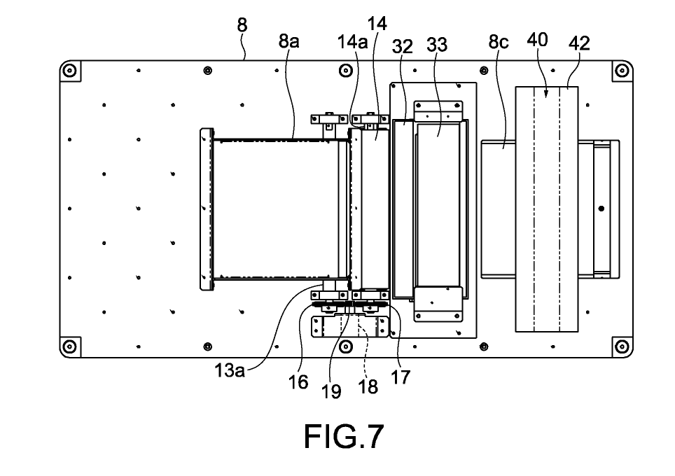

FIG. 6 is a perspective view showing the 3D modeling apparatus 100 from which the top plate 7 shown in FIG. 5 is detached. FIG. 7 is a plan view showing the 3D modeling apparatus 100 shown in FIG. 6. As shown in FIGS. 4 to 7, above the print base plate 8, a supply unit 10, a head unit 30, and a heater 40 are arranged in the stated order in the Y direction, that is, in a longitudinal direction of the 3D modeling apparatus 100. The supply unit 10 supplies a powder material (hereinafter, simply referred to as powder) to a modeling box 21 of a modeling unit 20.

As the powders, a water-soluble material, for example, an inorganic material such as salt, magnesium sulfate, magnesium chloride, potassium chloride, and sodium chloride is used. A mixture of sodium chloride with bittern components (magnesium sulfate, magnesium chloride, potassium chloride, or the like), that is, a material mainly containing sodium chloride may also be used for the powders. Alternatively, an organic material such as polyvinylpyrrolidone, polyvinyl alcohol, carboxymethyl cellulose, ammonium polyacrylate, sodium polyacrylate, ammonium meta-acrylate, and sodium meta-acrylate, or a copolymer thereof may be used. The polyvinylpyrrolidone or the like exhibits desirable adhesiveness, when water is added thereto, and a heating process is performed thereon. An average particle diameter of the powders is 10 μm or more and 100 μm or less. The use of the salt requires less energy for extracting or processing the powder material as compared to a case where metal or plastic is used for the powder material, and therefore is environmentally friendly. In addition, even if the material of the salt or polyvinylpyrrolidone is discarded, those materials do not adversely affect the environment.

An opening 7a is formed on the top plate 7. Through the opening 7a, the powders are supplied to the supply unit 10 by an operator or an operating robot. Further, a taking in/out opening 7b is formed on the top plate 7 so as to be adjacent to the opening 7a. Through the taking in/out opening 7b, the operator or the like takes in or out an ink tank unit 33 (described later) in the head unit 30.

As shown in FIG. 6, below the supply unit 10, a square hole 8a is formed on the print base plate 8. The shape and size of the hole 8a are not limited and can be designed as appropriate. For example, the shape of the hole 8a may be a slit shape elongated in an X direction perpendicular to the Y direction, as long as the powders can drop within the modeling box 21 as will be described later.

As shown in FIGS. 6 and 7, below the heater 40, a takeout opening 8c is formed on the print base plate 8. Through the takeout opening 8c, a 3D object created is taken out.

Below the print base plate 8 and the supply unit 10, the modeling unit 20 for forming a 3D object with the powders is disposed. The modeling unit 20 includes the modeling box 21 and a modeling stage 22. The modeling box 21 stores the powders supplied from the supply unit 10 therein. The modeling stage 22 is disposed in the modeling box 21, and on the modeling stage 22, the powders are accumulated. The modeling unit 20 further includes a lifting and lowering unit (lifting and lowering mechanism) 23 that supports the modeling box 21 and the modeling stage 22 and lifts or lowers the modeling stage 22 in the modeling box 21.

The supply unit 10 includes a supply box 11, an accumulation plate 12, and a supply roller 13. The supply box 11 is capable of storing the powders. The accumulation plate 12 is disposed to be inclined in the supply box 11. The supply roller 13 is disposed at a lower end portion of the accumulation plate 12. Above the supply box 11, an opening portion that is opposed to the opening 7a of the top plate 7 is formed, and the supply box 11 has an approximately cubic shape, for example. The accumulation plate 12 is inclined at about 40 to 50 degrees with respect to a horizontal plane (X-Y plane) and is disposed so that an accumulation surface (upper surface) 12a thereof, on which the powders are accumulated, faces the head unit 30, that is, is directed in a positive Y direction. The powders are accumulated on the accumulation plate 12 and then stored in a triangular prism area in the supply box 11.

The slope of the accumulation 12 is not limited to 40 to 50 degrees and may be set so that the powders are prevented from adhering to the accumulation surface 12a due to a friction and can be transferred to the modeling box 21 of the modeling unit 20. That is, the slope of the accumulation plate 12 can be set as appropriate depending on kinds, materials, or shapes of the powders or a quality of a material of the accumulation surface 12a.

The supply roller 13 has a rotation shaft 13a extended in the X direction, and has a shape elongated in the X direction within at least a range of forming the 3D object in the X direction in the modeling box 21. A sidewall 11a of the supply box 11 on the head unit 30 side is disposed so that a predetermined gap is given between a lower end of the sidewall 11a and a surface of the supply roller 13. When the supply roller 13 is rotated, the powders stored in the supply box 11 pass through the predetermined gap and are supplied into the modeling box 21. In addition, the gap is formed to be slim so that the powders on the accumulation plate 12 do not drop in the modeling box 21 through the gap in a state where the supply roller 13 is not rotated (is stopped).

The supply unit 10 includes a leveling roller 14 provided between the supply box 11 and the head unit 30. The leveling roller 14 is disposed so as to be aligned with the supply roller 13 in the Y direction. When the leveling roller 14 is rotated, the surface of the powders stored in the modeling stage 22 is leveled to be flat. The supply box 11, the accumulation plate 12, the supply roller 13, and the leveling roller 14 function as a supply mechanism. Like the supply roller 13, the leveling roller 14 also has a shape elongated in the X direction within at least a range of forming a 3D object is formed in the X direction in the modeling box 21.

As shown in FIG. 3, on the base plate 9, a movement mechanism 26 for moving the modeling unit 20 in the Y direction is provided. On a side of the modeling box 21, which is opposite to the head unit 30, a collection box 45 that collects extra powders is provided. The collection box 45 is provided above the lifting and lowering unit 23 or below the modeling box 21.

The lifting and lowering unit 23 is formed of, for example, a rack and pinion, a belt drive mechanism, or a linear motor driven by an electromagnetic force (those mechanisms are not shown). Instead of the lifting and lowering unit 23, a lifting and lowering cylinder that uses, for example, a fluid pressure may be used.

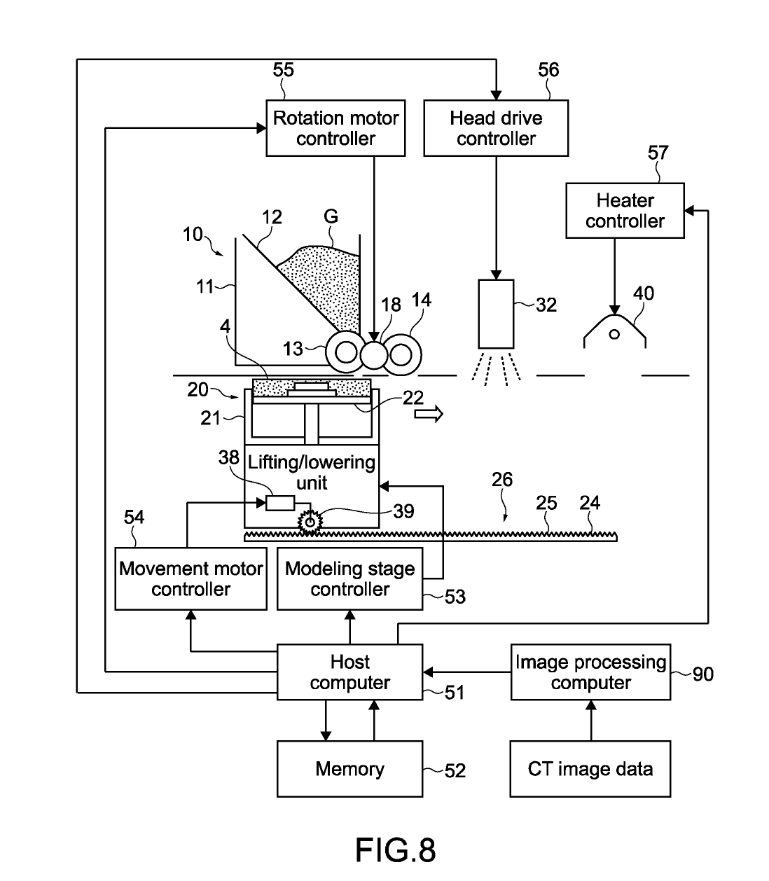

As shown in FIGS. 3 and 4, the movement mechanism 26 includes guide rails 25 and a drive mechanism. The guide rails 25 are provided on the base plate 9 so as to be extended in the Y direction, and the drive mechanism moves the lifting and lowering unit 23 in the Y direction along the guide rails 25. For example, as shown in FIG. 8, the drive mechanism includes a movement motor 38, a pinion gear 39 driven by the movement motor 38, a rack gear 24 (see, FIGS. 3 and 8) that is engaged with the pinion gear 39, and the like. The movement motor 38 is attached to, for example, the lifting and lowering unit 23 of the modeling unit 20. The drive mechanism may be formed of various mechanisms such as a ball screw, a belt drive, and a linear motor driven by an electromagnetic force, instead of the rack and pinion. With the movement mechanism 26 as described above, the modeling box 21, the modeling stage 22, the lifting and lowering unit 23, and the collection box 45 are integrally moved in the Y direction.

On a movement path of the modeling unit 20 in the Y direction by the movement mechanism 26 and above the modeling unit 20 on the movement path, the supply unit 10, the head unit 30, and the heater 40 are disposed.

The modeling box 21 has a footprint that is substantially the same as the supply box 11. In the vicinity of a right end portion of the modeling box 21 in a standby state at a standby position shown in FIG. 4, the supply roller 13 and the leveling roller 14 are provided. As shown in FIG. 6, in a position on the print base plate 8, at which the leveling roller 14 is disposed, an exposure hole 8b is formed. From the exposure hole 8b, a part of the surface of the leveling roller 14 is exposed below the print base plate 8.

As shown in FIGS. 5 and 7, as a drive source that drives the supply roller 13 and the leveling roller 14, a rotation motor 18 is provided on the print base plate 8. As shown in FIG. 7, a transmission gear 19 is connected to a drive output shaft of the rotation motor 18. To the transmission gear 19, gears 16 and 17 that are connected to the rotation shaft 13a of the supply roller 13 and a rotation shaft 14a of the leveling roller 14, respectively, are engaged at a predetermined gear ratio. The gear ratios with respect to the gears 16 and 17 by the transmission gear 19 may be the same or different from each other. When the rotation motor 18 is driven, the transmission gear 19 is rotated, and the rotation force is transmitted to the gears 16 and 17, thereby rotating the supply roller 13 and the leveling roller 14 in the same direction. In this way, the single drive source drives the supply roller 13 and the leveling roller 14, with the result that miniaturization of the 3D modeling apparatus 100 can be realized. Further, the cost thereof can also be reduced.

The head unit 30 includes the ink tank unit 33 and an inkjet head 32. On the ink tank unit 33, a plurality of ink tanks 31 is mounted. The ink jet head 32 is connected to the ink tank 31 through a tube (not shown). The inkjet head 32 ejects inks stored in the ink tanks 31 to the powders on the modeling stage 22. As shown in FIG. 6 and the like, the inkjet head 32 is fixed to a support stage 37 provided on the print base plate 8, and the ink tank unit 33 is provided on the support stage 37.

As shown in FIG. 6, as the inkjet head 32, a line-type head that is elongated in the X direction is used, for example. A width of ejection of the inks in the X direction is designed within at least a range of forming the 3D object in the X direction on the modeling stage 22. As an inkjet generation mechanism, a piezoelectric type or a thermal type may be used, and a known ejection principle may be used.

As the inks (liquids), color inks such as cyan, magenta, and yellow (hereinafter, abbreviated to CMY), and in addition to those inks, an ink such as black and white or a colorless ink may be used, for example. In particular, the ink tank 31 for the black, white, or colorless ink may be provided depending on the color of the powders as appropriate. In this embodiment, the materials of the powders and the inks are selected so that the powders are hardened due to a water content in the ink, for example. In a case where the powders are white and a 3-D object is intended to be white-colored (to be partly kept white), the colorless ink or the white ink is ejected to the part to be white-colored.

Further, for example, as the material of the ink, an aqueous ink is used, and a commercially available ink for an inkjet printer may also be used. Depending on the material of the powders, the ink may be an oil-based ink. As the colorless ink, a mixture of pure water and ethyl alcohol in a ratio by weight of 1:1, a mixture obtained by mixing glycerin into pure water by 20 wt %, or a mixture obtained by mixing a minute amount of surfactant into the above-mentioned mixture may be used.

Alternatively, the material of the ink is not limited to a material for coloring use. For example, a chemical containing a binder for binding the powders may be used.

The heater 40 includes an infrared lamp 41 and a reflector 42. The heating member is not limited to the infrared lamp 41, and an electrically-heated wire or an infrared laser (described later) may be used.

(Control System)

FIG. 8 is a block diagram mainly showing a control system of the 3D modeling apparatus 100.

The control system includes a host computer 51, a memory 52, an image processing computer 90, a modeling stage controller 53, a movement motor controller 54, a rotation motor controller 55, a head drive controller 56, and a heater controller 57.

The host computer 51 performs an overall control on the drives of the memory 52 and the various controllers. The memory 52 is connected to the host computer 51 and may be volatile or non-volatile.

The image processing computer 90 loads CT (computed tomography) image data as a cross-sectional image of a modeling-target object as will be described later, and performs image processings such as conversion of the CT image data into a BMP (bitmap) format. Typically, the image processing computer 90 is provided separately from the 3-D modeling apparatus 100 and connected to the host computer 51 via a USB (universal serial bus), and transmits, to the host computer 51, stored image data on which the image processing has been performed.

The CT is not limited to a CT using an X ray and means a broad CT including a SPECT (single photon emission CT), a PET (positron emission tomography), an MM (magnetic resonance imaging), and the like.

The form of the connection between the host computer 51 and the image processing computer 90 is not limited to the USB but may be an SCSI (small computer system interface) or another form. In addition, it makes no difference whether a wired connection or a wireless connection is used. It should be noted that the image processing computer 90 may be a device for image processings that is mounted on the 3-D modeling apparatus 100. Further, in the case where the image processing computer 90 is separated from the 3-D modeling apparatus 100, the image processing computer 90 may be a CT apparatus.

The modeling stage controller 53 controls the lifting and lowering drive amount of the lifting and lowering cylinder, in order to lowering the modeling stage 22 on a predetermined-height basis (as will be described later) at a time of printing on the powders G by using the inkjet head 32.

The movement motor controller 54 controls the drive of the movement motor 38 of the movement mechanism 26, thereby controlling the start or stop of the rotation of the modeling unit 20, a movement speed thereof, and the like.

The rotation motor controller 55 controls the drive of the rotation motor 18, thereby controlling the start or stop of the rotation of the supply roller 13 and the leveling roller 14, a rotation speed thereof, and the like.

The head drive controller 56 outputs, to an inkjet generation mechanism in the inkjet head 32, a drive signal in order to control the ejection amount of the ink.

The heater controller 57 controls the start or stop of a heating by the heater 40, a heating temperature, a heating time period, and the like.

The host computer 51, the image processing computer 90, the modeling stage controller 53, the rotation motor controller 55, the movement motor controller 54, the head drive controller 56, and the heater controller 57 may be implemented by the following hardware or combinations of the hardware and software. Examples of the hardware include a CPU (central processing unit), a DSP (digital signal processor), an FPGA (field programmable gate array), an ASIC (application specific integrated circuit), or hardware similar to those.

The memory 52 may be a solid-state memory (semiconductor, dielectric, or magneto-resistive memory) or a storage device such as a magnetic disc and an optical disc.

(Operation of 3-D Modeling Apparatus 100)

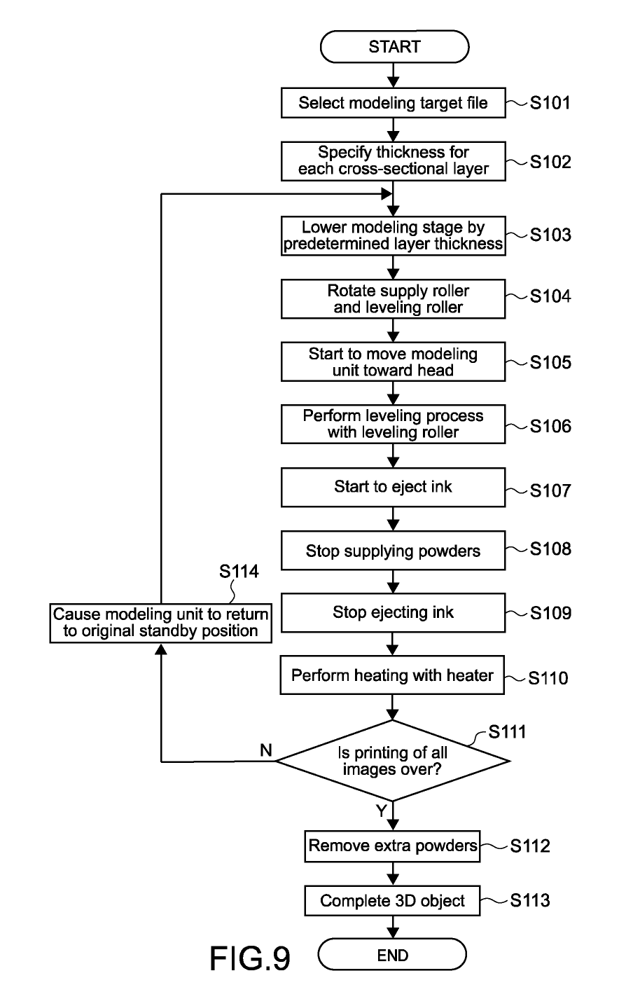

A description will be given on an operation of the 3-D modeling apparatus 100 (and the image processing computer 90) structured as described above. FIG. 9 is a flowchart showing the operation.

The image processing computer 90 reads CT image data. An object as a modeling target is an organism, in particular, a human body in the medical field. In addition to the medical field, CT image data of an architectural field, a mechanical engineering field, or the like may also be handled.

In Step 101, the operator operates the image processing computer 90 or the host computer 51 to select a file as a modeling target, that is, a CT image data group corresponding to one target object, for example.

Based on luminance information of the CT image selected, the image processing computer 90 may perform two-valued processing or three-or-more-valued processing on the luminances. In this case, the image processing computer 90 may perform, with respect to the image that has been subjected to the multivalued (two-or-more-valued) processing, coloring processing in accordance with the stepwise luminances corresponding to the multivalued processing. Through the multivalued processing and the coloring processing in accordance with the luminances, the 3D modeling apparatus 100 can form a 3D object, even the inside of which is color-coded or colored.

The host computer 51 loads, from the image processing computer 90, the CT image data group or the image data group that has been subjected to the image processing (multivalued processing, coloring processing, or the like) as described above. Hereinafter, for convenience of explanation, the CT image data and the image data that has been subjected to the image processing are collectively referred to as “cross-sectional image data”.

In Step 102, the operator operates the image processing computer 90, for example, to thereby specify a thickness of each cross section of the cross-sectional image data. The thickness of the cross sections of the cross-sectional image data corresponds to a thickness of one layer of powders G at a time when a printing processing is performed on the powders G on the modeling stage 22 as will be described later.

The thickness of one layer of the powders G may be less than or more than the thickness of each cross section of the original cross-sectional image data. For example, in a case where the thickness of each cross section of the original cross-sectional image data is 1 mm, the thickness of one layer of the powders G may be set to 0.1 mm. In this case, in accordance with the one cross-sectional image data item, the 3D modeling apparatus 100 may print the same image on each of 10 layers (0.1 mm×10) of the powders G. Alternatively, the thickness of one layer of the powders G may be set to be the same as the thickness of each cross section of the original cross-sectional image data.

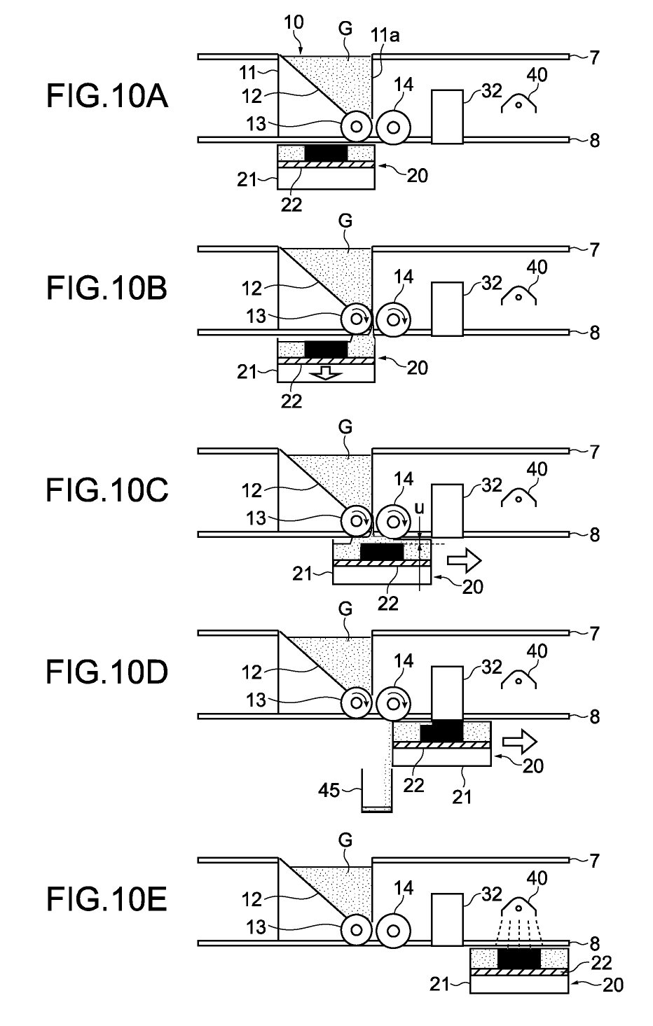

Next, for example, when the operator presses a start button (not shown), the 3D modeling apparatus 100 starts the operation. FIGS. 10A to 10E are schematic diagrams each showing the operation. FIGS. 10A to 10E show a process of forming one layer (predetermined layer thickness) of the powders G to be hardened by the ink ejection as will be described later. The powders G and the powders G that are not yet hardened are indicated by a dotted area, and a hardened layer is indicated by a blackened area.

As shown in FIG. 10A, on the modeling stage 22, the hardened layer and the powder layers that are not hardened are laminated. In this state, the process of forming one hardened layer is started. In FIG. 10A, a position at which the modeling unit 20 is disposed corresponds to a standby position of the modeling unit 20.

First, by driving the lifting and lowering unit 23, the modeling stage 22 is lowered by a predetermined layer thickness as shown in FIG. 10B (Step 103). When the rotation motor 18 is driven, the supply roller 13 and the leveling roller 14 are rotated (Step 104). The rotation direction of the rollers is a clockwise direction in FIG. 4. When the roller 13 (and the roller 14) is rotated, the powders G accumulated on the accumulation plate 12 of the supply box 11 are caused to drop through the gap between the lower end of the sidewall 11a and the surface of the roller 13 due to the rotation force of the roller 13 and a weight thereof.

In this way, during the movement of the modeling stage 22, the powders G are supplied onto the modeling stage 22 from the accumulation surface 12a by using at least the weight thereof. Therefore, it is unnecessary to move the supply roller 13 and the leveling roller 14 in order to laminate one layer of the powders G on the modeling stage 22. In other words, the supply unit 10 can be fixed to the 3D modeling apparatus 100, which makes the structure of a movement system simple.

In addition, in FIG. 10B, by driving the movement mechanism 26, at a timing when the supply roller 13 and the leveling roller 14 are started to be rotated or after a predetermined time elapses from the timing, the modeling unit 20 starts to move toward the inkjet head 32 (Step 105). During the movement of the modeling unit 20, the supply roller 13 (and the leveling roller 14) continues to be rotated, and the powders G continue to be supplied in the modeling box 21.

As shown in FIG. 10C, when the leveling roller 14 is positioned above the modeling box 21 by the movement of the modeling unit 20, a surface of the powders G is leveled (Step 106). With this operation, the state shown in FIG. 10A is shifted to a state where the powders G of the one layer is accumulated on the modeling stage 22. A thickness u of the one layer is set to 0.1 mm, for example, as described above.

The rotation direction of the leveling roller 14 is a clockwise direction in FIG. 4. The rotation direction corresponds to a direction reverse to a direction in which the leveling roller 14 is expected to be rotated due to a friction between the leveling roller 14 and the powder layer on the modeling stage 22 in a state where the rotation shaft 14a of the leveling roller 14 is free. The rotation of the leveling roller 14 can improve an effect of uniformly leveling the powders G.

As shown in FIG. 10D, when the modeling box 21 is moved to a predetermined position by the movement of the modeling unit 20, the inkjet head 32 starts ejection of the ink in accordance with the control by the head drive controller 56 (Step 107). As a result, the hardened layer is formed in a predetermined selected area in the one powder layer accumulated on the modeling stage 22. When the material of the powders G and the kind of the ink that are capable of binding the powders are selected as appropriate, the hardened layer can be formed. A commercially available aqueous ink can be a liquid for hardening the powders G mainly containing sodium chloride, for example. In addition, depending on the material of the powders G, for example, in a case where the powders G are copolymers with the organic material described above, water functions as the liquid for hardening the material of the powders G.

In FIG. 10D, when a rear end portion (left end in the figure) of the modeling box 21 passes the lower portion of the leveling roller 14, the supply roller 13 (and the leveling roller 14) is stopped (Step 108). As a result, the supply of the powders G to the modeling box 21 is stopped.

Further, as shown in FIG. 10D, the modeling unit 20 continues to be moved, extra powders G dropped out of the modeling box 21 are collected by the collection box 45. Therefore, the powders G collected can be reused.

Then, when the supply of the ink to the predetermined selected areas of the powder layer is completed, the inkjet head 32 stops the ejection (Step 109). It should be noted that Steps 108 and 109 may be performed substantially at the same time in some cases.

When the modeling unit 20 further continues to be moved, the modeling box 21 is moved to a position immediately below the heater 40 as shown in FIG. 10E. At this position, the powders G of the one layer on the modeling stage 22 are heated by the heater 40 (Step 110). The heating temperature is set to, for example, 100 to 200° C. but is not limited to this range. By the heating process, the hardness of the powders G of the hardened layer is increased, and the hardened layer is baked. In a case where the binding force of the powders by the ink ejected from the head is not enough, and therefore the hardness of the 3D object is insufficient, the heating process by the heater 40 can provide a desired hardness of the 3D object.

When the heating process is over, the host computer 51 judges whether the printing of all the cross-sectional images corresponding to the target object is completed or not (Step 111). In a case where the printing is completed, extra powders G in the modeling box 21 is removed, because the 3D object is surrounded by the powder layers that are not hardened (Step 112), thereby completing the 3D object (Step 113). Then, a person or a robot (not shown) takes out the 3D object from the 3D modeling apparatus 100.

In Step 111, in a case where the printing of all the cross-sectional images corresponding to the target object is not completed, the modeling unit 20 is returned to the position immediately below the supply box 11, that is, the original standby position (Step 114), and the processings of Step 103 and subsequent steps are repeatedly performed. It should be noted that after Step 114, the modeling stage 22 may be lowered during the movement to the standby position of the modeling unit, in addition to the case where the modeling stage 22 is lowered in Step 103.

As described above, in this embodiment, the modeling unit 20 is moved with the movement mechanism 26, and therefore the supply of the powders G and the ejection of the ink can be performed without moving the supply unit 10 and the inkjet head 32 in the Y direction. That is, the supply of at least one of the powders G and the ink can be performed only by moving the modeling unit 20 with the movement mechanism 26, which makes the structure of the movement system simple. The movement system refers to a mechanism that moves the members and is necessary for forming the 3D object of predetermined layer thicknesses of the powders G.

In this embodiment, the supply box 11 is disposed above the modeling box 21, and therefore the footprint of the 3D modeling apparatus 100 can be reduced.

In this embodiment, in the direction in which the modeling unit 20 is moved, the leveling roller 14, the inkjet head 32, and the heater 40 are arranged in the stated order, and the modeling unit 20 is moved only in one direction, that is, in the positive Y direction at the time of printing of the powders G of one layer. Therefore, at the time of printing of the powders G of one layer, the modeling unit 20 does not have to reciprocate in the Y direction, which can reduce a tact time.

In this embodiment, the movement speed of the modeling unit 20 by the movement mechanism 26 may be constant, but may be accelerated or decelerated during the movement.

In this embodiment, the 3D object is formed of the powder material containing salt or the like, and the printing is performed with the ink that does not contain an adhesive unlike related art. Therefore, it is possible to cut cost of the ink. Further, because the adhesive is not used, it is possible to prevent a problem of causing the adhesive to get hard at the ejection opening of the inkjet head, which can prevent clogging of the ejection opening.

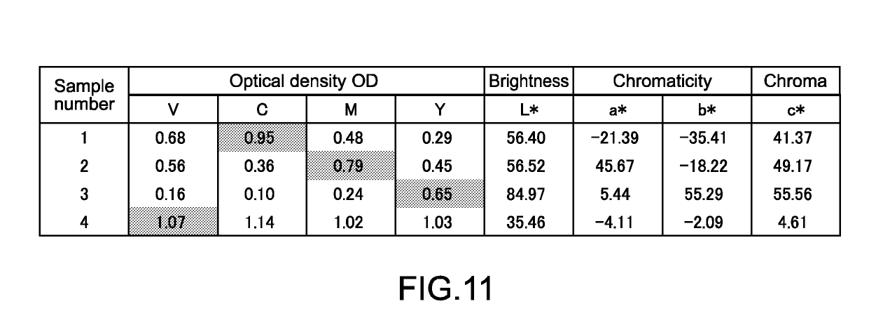

FIG. 11 is a table showing an example of measurement values of four 3D object samples formed by the 3D modeling apparatus 100 according to this embodiment. The inventors of the present invention obtained the values of an optical density, a brightness, a chromaticity, and a chroma by using X-Rite 530 manufactured by X-Rite incorporated. The material of the powders G of each of the 3D object samples contained salt of 90 wt % or more, and polyvinylpyrrolidone and the like were used as the material. A 3D object formed of gypsum as a base in related art has just white or gray color. In contrast, in this embodiment, the values of the chroma are large, and thus a desirable color appearance is obtained.

The optical density (OD) is expressed by the following expression:

OD=−log 10(I′/I)

where I represents an intensity of incident light to the 3-D object, and I′ represents an intensity of reflection light from the 3-D object.

That is, in a case where a reflectance is 10%, OD=−log 10(0.1)=1 is obtained.

### Second Embodiment

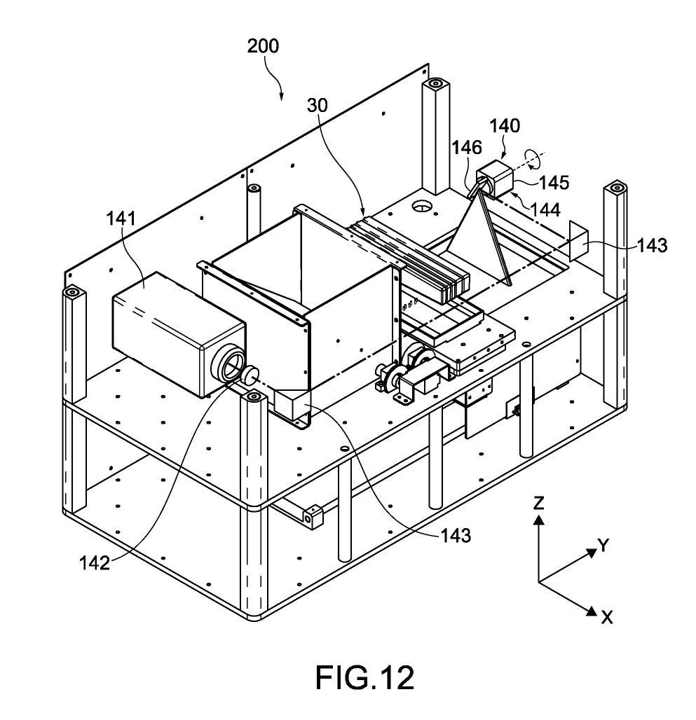

FIG. 12 is a perspective view showing a part of a 3D modeling apparatus according to a second embodiment of the present invention. In the following, descriptions of members or functions that are the same as those of the 3D modeling apparatus 100 according to the first embodiment shown in FIG. 1 and the like will be simplified or omitted, and different points will be mainly described.

A 3D modeling apparatus 200 according to this embodiment includes a heater 140 that uses laser light for a heating process. The heater 140 is provided with a laser light source 141, lens 142 for forming a parallel light flux, two reflection mirrors 143, and an optical scan mechanism 144.

The laser light source 141 is disposed in an area between the top plate 7 and the print base plate 8, for example, on a lower surface of the top plate 7. For example, the laser light source 141 emits infrared laser light whose wavelength is 808 nm, but laser light having a far-infrared wavelength may instead be used.

The optical scan mechanism 144 includes a servo motor 145 and a galvano mirror 146. The optical scan mechanism 144 is aligned with the head unit 30 in the Y direction, and disposed on the opposite side to the laser light source 141 in the Y direction. The two reflection mirrors 143 are disposed at appropriate positions so as to guide a laser beam to the optical scan mechanism 144. The lens 142 is disposed on an optical path between the laser light source 141 and one of the reflection mirrors 143.

The galvano mirror 146 of the optical scan mechanism 144 is rotated so as to be reciprocated within a predetermined angle range about an axis of the Y direction by the drive of the servo motor 145. The angle range is set as appropriate so that a range in which the laser beam is reflected by the galvano mirror 146 and focused on the powder layer on the modeling stage 22 covers a predetermined range in which the 3D object is formed. Further, the speed of the reciprocating rotation of the galvano mirror 146 by the servo motor 145 is also set as appropriate.

With the optical scan mechanism 144 as described above, the laser beam is formed linearly in the X direction, and the linear light beam is focused on the powders G. Therefore, the powders G are irradiated with the linear light beam while the modeling unit 20 is moved by the movement mechanism 26, thereby heating the one powder layer (entire surface of the plane-shaped powder layer).

By using the laser as described above, the powders G of the one layer can be formed in a short time period, with the result that the total time period required for forming a whole 3D object can be reduced.

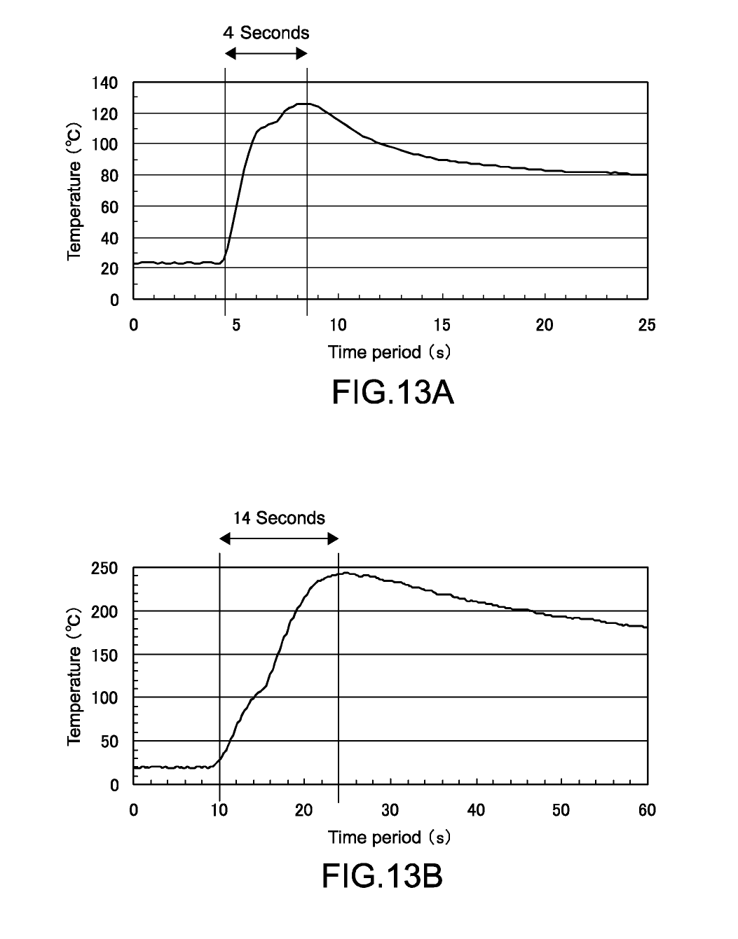

FIGS. 13A and 13B are graphs each showing an example of an operation of the heater 140 by the heater controller 57 that uses the infrared laser. In each of the graphs, a horizontal axis represents a time period (s), and a vertical axis represents a heating temperature (° C.). As shown in FIGS. 13A and 13B, temperature rise velocities of about 4 seconds and 14 seconds, respectively, were obtained, and in both cases, the object succeeded in being formed.

It should be noted that in the second embodiment shown in FIG. 12, the linear scanning is performed with the laser beam by using the galvano mirror 146. But, the galvano mirror 146 and the servo motor 145 may be moved in the Y direction to perform a planar scanning in the X and Y directions with the laser beam.

### Third Embodiment

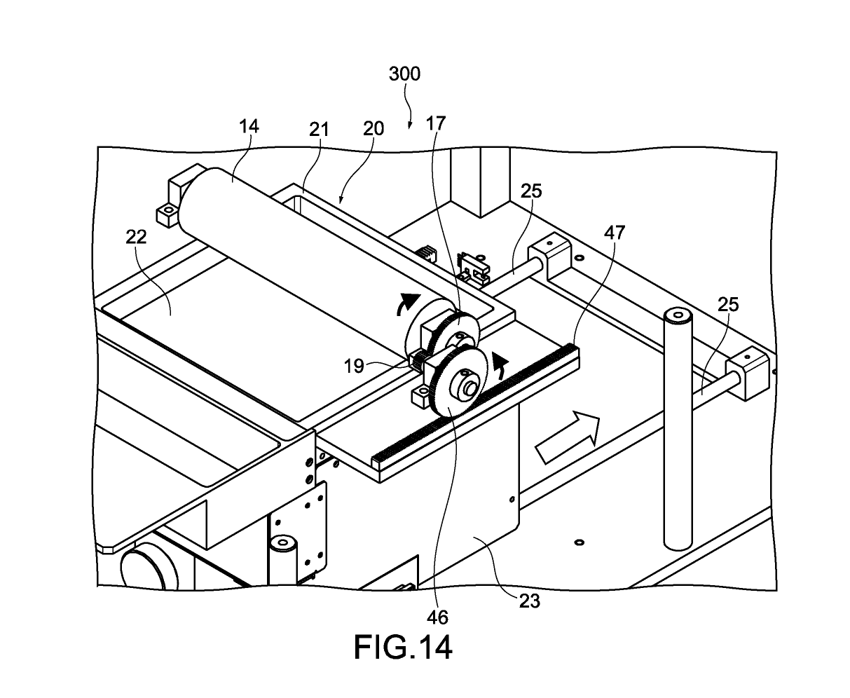

FIG. 14 is a perspective view showing a part of a 3D modeling apparatus according to a third embodiment of the present invention.

A 3D modeling apparatus 300 according to this embodiment is provided with a rack gear 47 attached to the modeling box 21, a pinion gear 46 engaged with the rack gear 47, and the transmission gear 19 connected to the pinion gear 46. In FIG. 14, the supply roller 13 and the gear 16 therefor (see, FIG. 5) are not shown. The transmission gear 19 is connected to the gear 16 for the supply roller 13 and to the gear 17 of the leveling roller 14 at a predetermined gear ratio. With this structure, the supply roller 13 and the leveling roller 14 can be rotated by using power of the movement of the modeling unit 20 in the Y direction. In this case, the rack gear 47, the pinion gear 46, and the transmission gear 19 function as a power transmission mechanism.

The power transmission mechanism as described above is provided, thereby making it possible to rotate the supply roller 13 and the leveling roller 14 with the one drive source (movement motor 38) that drives the modeling unit 20, with the result that the miniaturization of the 3D modeling apparatus 300 can be realized. In addition, only one drive source is used, which can realize the cost reduction.

The present application is not limited to the above embodiments, and various other embodiments can be considered.

In the above embodiments, the supply roller 13 and the leveling roller 14 are driven by the one rotation motor 18. Alternatively, the rollers 13 and 14 may be separately driven by different rotation motors.

The intervals in the Y direction among the supply roller 13, the leveling roller 14, the inkjet head 32, and the heater 40 are not limited to those shown in FIG. 4 and the like, but the design can be changed as appropriate.

In the above embodiments, the number of the supply roller 13 is set to one. But, for example, two supply rollers that are disposed with a gap that allows the powders to pass therethrough may be rotated in opposite directions to each other, and the powders may be supplied through the gap. Also, a plurality of leveling rollers 14 may be provided.

In the above embodiments, the inkjet head 32 has the line-type head. Alternatively, the inkjet head 32 may be a scan-type inkjet head that has a width for ejection shorter in the X direction than the above inkjet head 32 and is capable of moving in the X direction.

The accumulation surface 12a of the accumulation plate 12 disposed in the supply box 11 may have a curved shape, and the curbed surface may be convex upward or downward.

As the mechanism that causes the powders G to drop from the supply box 11, a vibration unit that vibrates the accumulation surface 12a may be used instead of or in addition to the supply roller 13. As the vibration unit, a piezoelectric actuator or an eccentric motor may be used. The vibration may be an ultrasonic vibration.

An opening may be formed on a lower portion of the supply box, and a shutter that opens and closes the opening may be provided.

In the above embodiments, the heater 40 is provided, but may not necessarily be provided. A heating apparatus that heats a 3D object obtained by the 3D modeling apparatus 200 that does not have the heater 40 may be provided separately from the 3D modeling apparatus 200.

It should be understood that various changes and modifications to the presently preferred embodiments described herein will be apparent to those skilled in the art. Such changes and modifications can be made without departing from the spirit and scope and without diminishing its intended advantages. It is therefore intended that such changes and modifications be covered by the appended claims.

The application is claimed as follows:

1. A three-dimensional modeling apparatus, comprising:
a stage on which a powder material is accumulated;
a supply mechanism to supply the powder material on the stage for each predetermined layer thickness;
a head to eject a liquid for forming a three-dimensional object to the powder material on the stage, the liquid being capable of binding the powder material;
a movement mechanism to move the stage so that the liquid is supplied from the head to the powder material by the predetermined layer thickness; and
a lifting and lowering mechanism to lower the stage for each predetermined layer thickness.

2. The three-dimensional modeling apparatus according to claim 1,
wherein the supply mechanism includes
a supply box capable of storing the powder material and disposed above the stage on a path of movement of the stage by the movement mechanism,
an accumulation surface inclined in the supply box, the powder material being accumulated on the accumulation surface, and
a dropper mechanism to cause the powder material accumulated on the accumulation surface to drop on the stage by a weight of the powder material during the movement of the stage by the movement mechanism.

3. The three-dimensional modeling apparatus according to claim 2,
wherein the dropper mechanism is a supply roller disposed on a lower end portion of the accumulation surface.

4. The three-dimensional modeling apparatus according to claim 2,
wherein the supply mechanism further includes a leveling roller to level the powder material dropped on the stage.

5. The three-dimensional modeling apparatus according to claim 2,
wherein the supply mechanism includes
a supply roller to function as the dropper mechanism, the supply roller being disposed on a lower end portion of the accumulation surface,
a leveling roller to level the powder material dropped on the stage, and
a drive source to drive the supply roller and the leveling roller.

6. The three-dimensional modeling apparatus according to claim 3, further comprising:
a power transmission mechanism to drive the supply roller to rotate by using power of the stage, the power being caused when the stage is moved by the movement mechanism.

7. The three-dimensional modeling apparatus according to claim 4, further comprising:
a power transmission mechanism to drive the leveling roller to rotate by using power of the stage, the power being caused when the stage is moved by the movement mechanism.

8. The three-dimensional modeling apparatus according to claim 1, further comprising:
a heater to heat the powder material on the stage, to which the liquid is supplied.

9. The three-dimensional modeling apparatus according to claim 8,
wherein the heater emits laser light for heating.

10. The three-dimensional modeling apparatus according to claim 1,
wherein the head is a line-type head that is fixed on a position above the stage on a path of movement of the stage by the movement mechanism and elongated in a direction perpendicular to a movement direction of the stage.

11. The three-dimensional modeling apparatus according to claim 1,
wherein the powder material mainly contains sodium chloride.

12. A three-dimensional object obtained by a three-dimensional modeling apparatus including
a stage on which a powder material is accumulated,
a supply mechanism to supply the powder material on the stage for each predetermined layer thickness,
a head to eject a liquid for forming a three-dimensional object to the powder material on the stage, the liquid being capable of binding the powder material,
a movement mechanism to move the stage so that the liquid is supplied from the head to the powder material by the predetermined layer thickness, and
a lifting and lowering mechanism to lower the stage for each predetermined layer thickness.
